(19) United States
(12) Patent Application Publication
(10) Pub. No.: US 2012/0196374 A1
(43) Pub. Date: Aug. 2, 2012

(54) DISPENSER, ANALYZER AND DISPENSING METHOD

(75) Inventor: Tadashi Haga, Shizuoka (JP)

(73) Assignee: Beckman Coulter, Inc., Brea, CA (US)

(21) Appl. No.: 13/442,798

(22) Filed: Apr. 9, 2012

Related U.S. Application Data
(63) Continuation of application No. PCT/JP2010/005998, filed on Oct. 6, 2010.

(30) Foreign Application Priority Data
Oct. 9, 2009 (JP) 2009-235626

(51) Int. Cl. G01N 35/02; B01L 3/02; G01N 21/00

(52) U.S. Cl. 436/50; 422/67

(57) ABSTRACT

A dispenser, analyzer and dispensing method are provided, which can dispense a predetermined amount of a blood cell sample without being influenced by an individual difference of the blood cell sample. The apparatus according to the present invention includes: a pressure sensor measuring pressure within a pipe during liquid suction by a dispensing probe, a calculation section calculating an average pressure value during liquid suction, measured by the pressure sensor; a storage section storing a correlation between the average pressure value and a discharge operation amount during liquid suction for each desired discharge amount; a correction section correcting the discharge operation amount based on the average pressure amount during suction calculated by the calculation section and the correlation stored in the storage section; and a control section controlling a syringe pump based on the discharge operation amount corrected by the correction section to discharge the desired discharge amount.

### TECHNICAL FIELD

The present invention relates to a dispenser for dispensing a liquid including a sample or reagent; an analyzer comprising the dispenser; and a dispensing method.

### BACKGROUND ART

Conventionally, in an analyzer for analyzing a reactant of a sample and a reagent, a dispenser for dispensing a sample or a reagent applies a negative pressure or a positive pressure to dispensing water, which is filled inside a pipe connected to a dispensing probe, using a syringe pump or the like. The dispenser then sucks a sample added with an excess amount in consideration of dilution with the dispensing water from the dispensing probe, and the dispenser discharges a given amount of the sample. The dispensing accuracy of the dispenser has a great influence on the accuracy of analysis performed by using the liquid sample, and therefore, improvement on dispensing accuracy of dispensers is a problem to be solved of extreme importance. Particularly in a case where dispensing of blood cell samples is performed in a blood analyzer, there has been a problem of differences in dispensing amounts among samples because blood cell samples not only have higher viscosity, but also have wider variations in viscosity due to individual differences, compared to blood plasma samples.

For this problem, a dispenser is disclosed for improving dispensing accuracy, where the dispenser comprises a suction and discharge section and a liquid suction mechanism, and the dispenser is capable of measuring pressure of a liquid to be dispensed at the suction by a pressure detecting means, generating discharging pressure by a discharging pressure generating mechanism, and adjusting a discharging amount by a discharging amount adjusting mechanism, and where adjustment of discharging pressure and discharging time based on the pressure at the suction enables accurate dispensing regardless of viscosity of the liquid to be dispensed (see, for example, Patent Literature 1).

### CITATION LIST

### Patent Literature

Patent Literature 1: Japanese Laid-Open Publication No. 2005-291998

### DISCLOSURE OF THE INVENTION

### SUMMARY OF INVENTION

### Technical Problem

In the dispenser described in Patent Literature 1, the discharging amount of liquid is adjusted by adjusting opening and closing time of an on-off valve used as a discharging amount adjusting mechanism. With such an adjustment of discharging amounts with opening and closing time of an on-off valve, however, a dispensing mechanism is prone to cause a malfunction because residual pressure is applied within a pipe. This is not a favorable occurrence. Furthermore, the Patent Literature above describes that a control section controls a pressurizing time by the discharging amount adjusting mechanism, and adjusts discharging pressure at the discharge by the discharging pressure generating mechanism, based on the pressure at the liquid suction. However, there is no disclosure therein with regard to a controlling method of a pressurizing time and discharging pressure of a syringe pump used as the discharging pressure generating mechanism, and the controlling thereof is inferred to be extremely difficult.

The present invention is intended to solve such a problem as described above. It is an objective of the present invention to provide a dispenser, an analyzer, and a dispensing method, in which a given amount of a blood cell sample can be dispensed without an influence of an individual difference in the blood cell sample.

### Solution to Problem

In order to solve the problem described above and achieve an objective of the present invention, a dispenser according to the present invention applies suction pressure or discharge pressure by pressure generating means through pressurized-out water filled in a pipe connected with a dispensing probe, and sucks and discharges a liquid including a sample or a reagent by a dispensing probe, the dispenser comprising: pressure measuring means for measuring pressure within the pipe during liquid suction by the dispensing probe; calculating means for calculating an average pressure value during liquid suction measured by the pressure measuring means; storage means for storing a correlation between an average pressure value and a discharge operation amount during liquid suction, set for each predetermined discharge amount; correction means for correcting a discharge operation amount of the pressure generating means, based on a correlation stored in the storage means, using the average pressure value during suction calculated by the calculating means; and control means for controlling the pressure generating means to allow a predetermined discharge amount to be discharged from the dispensing probe, based on the discharge operation amount corrected by the correction means.

Alternatively, the present invention provides a dispenser of a liquid including a sample or a reagent, the dispenser comprising: pressure generating means for applying suction pressure or discharge pressure through pressurized-out water filled in a pipe connected with a dispensing probe; a dispensing probe for sucking and discharging a liquid including a sample or a reagent; pressure measuring means for measuring pressure within the pipe during liquid suction by the dispensing probe; calculating means for calculating an average pressure value during liquid suction measured by the pressure measuring means; storage means for storing a correlation between an average pressure value and a discharge operation amount during liquid suction, set for each predetermined discharge amount; correction means for correcting a discharge operation amount of the pressure generating means, based on a correlation stored in the storage means, using the average pressure value during suction calculated by the calculating means; and control means for controlling the pressure generating means to allow a predetermined discharge amount to be discharged from the dispensing probe, based on the discharge operation amount corrected by the correction means.

Further, a dispenser according to the present invention applies suction pressure or discharge pressure by pressure generating means through pressurized-out water filled in a pipe connected with a dispensing probe, and sucks and discharges a liquid including a sample or a reagent by a dispensing probe, the dispenser comprising: pressure generating means for applying suction pressure or discharge pressure through pressurized-out water filled in a pipe connected with a dispensing probe; a dispensing probe for sucking and discharging a liquid including a sample or a reagent; pressure measuring means for measuring pressure within the pipe during liquid suction by the dispensing probe; calculating means for calculating a pressure integral value during liquid suction measured by the pressure measuring means; storage means for storing a correlation between a pressure integral value and a discharge operation amount during liquid suction, set for each predetermined discharge amount; correction means for correcting a discharge operation amount of the pressure generating means, based on a correlation stored in the storage means, using the pressure integral value during suction calculated by the calculating means; and control means for controlling the pressure generating means to discharge a predetermined discharge amount from the dispensing probe, based on the discharge operation amount corrected by the correction means.

Alternatively, the present invention provides a dispenser of a liquid including a sample or a reagent, the dispenser comprising: pressure generating means for applying suction pressure or discharge pressure through pressurized-out water filled in a pipe connected with a dispensing probe; a dispensing probe for sucking and discharging a liquid including a sample or a reagent; pressure measuring means for measuring pressure within the pipe during liquid suction by the dispensing probe; calculating means for calculating a pressure integral value during liquid suction measured by the pressure measuring means; storage means for storing a correlation between a pressure integral value and a discharge operation amount during liquid suction, set for each predetermined discharge amount; correction means for correcting a discharge operation amount of the pressure generating means, based on a correlation stored in the storage means, using the pressure integral value during suction calculated by the calculating means; and control means for controlling the pressure generating means to discharge a predetermined discharge amount from the dispensing probe, based on the discharge operation amount corrected by the correction means.

Further, in one embodiment, in the dispenser according to the present invention, the pressure generating means is a syringe pump in the invention described above.

Further, in another embodiment, in the dispenser according to the present invention, liquid discharging by the dispensing probe is performed at a predetermined discharging rate in the invention described above.

Further, in another embodiment, in the dispenser according to the present invention, the sample is a blood cell sample or a whole blood sample in the invention described above.

Further, in another embodiment, an analyzer according to the present invention analyzes a reactant of a sample and a reagent based on optical measurement, the analyzer using any one of the dispensers described above to dispense a sample or a reagent.

In various embodiments, an apparatus according to the present invention comprises any one or plurality of the characteristics described above of the dispenser according to the present invention.

Further, a dispensing method according to the present invention is for a dispenser that applies suction pressure or discharge pressure by pressure generating means through pressurized-out water filled within a pipe connected to a dispensing probe, sucks and discharges a liquid including a sample or a reagent by the dispensing probe, the method comprising: a pressure measuring step of measuring pressure within the pipe during liquid suction by the dispensing probe; a calculating step of calculating an average pressure value during liquid suction measured at the pressure measuring step; a correcting step of correcting a discharge operation amount of the pressure generating means, using the average pressure value during suction calculated at the calculating step, based on a correlation between an average pressure value and a discharge operation amount, set for each predetermined discharge amount, stored in storage means; and a discharge step of controlling the pressure generating means and allowing a predetermined discharge amount to be discharged from the dispensing probe, based on the discharge operation amount corrected at the correcting step.

Further, a dispensing method according to the present invention is for a dispenser that applies suction pressure or discharge pressure by pressure generating means through pressurized-out water filled within a pipe connected to a dispensing probe, and sucks and discharges a liquid including a sample or a reagent by the dispensing probe, the method comprising: a pressure measuring step of measuring pressure within the pipe during liquid suction by the dispensing probe; a calculating step of calculating a pressure integral value during liquid suction measured at the pressure measuring step; a correcting step of correcting a discharge operation amount of the pressure generating means, using the pressure integral value during suction calculated at the calculating step, based on a correlation between a pressure integral value and a discharge operation amount, set for each predetermined discharge amount, stored in storage means; and a discharge step of controlling the pressure generating means and allowing a predetermined discharge amount to be discharged from the dispensing probe, based on the discharge operation amount corrected at the correcting step.

In various embodiments, a method according to the present invention comprises any one or plurality of the characteristics described above of the dispenser according to the present invention.

Alternatively, the present invention provides a control program used in a dispensing method for a dispenser that applies suction pressure or discharge pressure by pressure generating means through pressurized-out water filled within a pipe connected to a dispensing probe, and sucks and discharges a liquid including a sample or a reagent by the dispensing probe. The control program is for implementing processing executed by the dispenser in accordance with an instruction from an operator, the dispenser comprising a storage section that stores a plurality of sets of a series of executive processing procedures executed by the dispenser, and each plurality of sets of a series of executive processing procedures corresponding to a series of operation procedures by the operator, the dispensing method comprising: a pressure measuring step of measuring pressure within the pipe during liquid suction by the dispensing probe; a calculating step of calculating an average pressure value during liquid suction measured at the pressure measuring step; a correcting step of correcting a discharge operation amount of the pressure generating means, using the average pressure value during suction calculated at the calculating step, based on a correlation between an average pressure value and a discharge operation amount, set for each predetermined discharge amount, stored in storage means; and a discharge step of controlling the pressure generating means and allowing a predetermined discharge amount to be discharged from the dispensing probe, based on the discharge operation amount corrected at the correcting step.

Alternatively, the present invention provides a control program used in a dispensing method for a dispenser that applies suction pressure or discharge pressure by pressure generating means through pressurized-out water filled within a pipe connected to a dispensing probe, and sucks and discharges a liquid including a sample or a reagent by the dispensing probe, the control program being for implementing processing executed by the dispenser in accordance with an instruction from an operator, the dispenser comprising a storage section that stores a plurality of sets of a series of executive processing procedures executed by the dispenser, and each plurality of sets of a series of executive processing procedures corresponding to a series of operation procedures by the operator, the dispensing method comprising: a pressure measuring step of measuring pressure within the pipe during liquid suction by the dispensing probe; a calculating step of calculating a pressure integral value during liquid suction measured at the pressure measuring step; a correcting step of correcting a discharge operation amount of the pressure generating means using the pressure integral value during suction calculated at the calculating step, based on a correlation between a pressure integral value and a discharge operation amount, set for each predetermined discharge amount, stored in storage means; and a discharge step of controlling the pressure generating means and allowing a predetermined discharge amount to be discharged from the dispensing probe, based on the discharge operation amount corrected at the correcting step.

In various embodiments, a program according to the present invention comprises any one or plurality of the characteristics described above of the dispenser and method according to the present invention.

Alternatively, the present invention provides a computer-readable recording medium for recording a control program used in a dispensing method for a dispenser that applies suction pressure or discharge pressure by pressure generating means through pressurized-out water filled within a pipe connected to a dispensing probe, and sucks and discharges a liquid including a sample or a reagent by the dispensing probe, the control program being for implementing processing executed by the dispenser in accordance with an instruction from an operator, the dispenser comprising a storage section that stores a plurality of sets of a series of executive processing procedures executed by the dispenser, and each plurality of sets of a series of executive processing procedures corresponding to a series of operation procedures by the operator, the dispensing method comprising: a pressure measuring step of measuring pressure within the pipe during liquid suction by the dispensing probe; a calculating step of calculating an average pressure value during liquid suction measured at the pressure measuring step; a correcting step of correcting a discharge operation amount of the pressure generating means, using the average pressure value during suction calculated at the calculating step, based on a correlation between an average pressure value and a discharge operation amount, set for each predetermined discharge amount, stored in storage means; and a discharge step of controlling the pressure generating means and allowing a predetermined discharge amount to be discharged from the dispensing probe, based on the discharge operation amount corrected at the correcting step.

Alternatively, the present invention provides a computer-readable recording medium for recording a control program used in a dispensing method for a dispenser that applies suction pressure or discharge pressure by pressure generating means through pressurized-out water filled within a pipe connected to a dispensing probe, and sucks and discharges a liquid including a sample or a reagent by the dispensing probe, the control program being for implementing processing executed by the dispenser in accordance with an instruction from an operator, the dispenser comprising a storage section that stores a plurality of sets of a series of executive processing procedures executed by the dispenser, and each plurality of sets of a series of executive processing procedures corresponding to a series of operation procedures by the operator, the dispensing method comprising: a pressure measuring step of measuring pressure within the pipe during liquid suction by the dispensing probe; a calculating step of calculating a pressure integral value during liquid suction measured at the pressure measuring step; a correcting step of correcting a discharge operation amount of the pressure generating means using the pressure integral value during suction calculated at the calculating step, based on a correlation between a pressure integral value and a discharge operation amount, set for each predetermined discharge amount, stored in storage means; and a discharge step of controlling the pressure generating means and allowing a predetermined discharge amount to be discharged from the dispensing probe, based on the discharge operation amount corrected at the correcting step.

In various embodiments, a recording medium according to the present invention comprises any one or plurality of the characteristics described above of the dispenser, method and program according to the present invention.

### Advantageous Effects of Invention

In the present invention, the calculating means calculates an average pressure value from in-line pressure data during liquid suction measured by the pressure measuring means; the correction means corrects a discharge operation amount of the pressure generating means, for discharging a predetermined discharge amount, based on a correlation between an average pressure value and a discharge operation amount during liquid suction at a desired discharge amount stored in storage means; and the control means controls the pressure generating means based on the discharge operation amount to allow a predetermined discharge amount to be discharged from the dispensing probe. Therefore, the present invention exerts an effect of being able to dispense a predetermined amount of a sample regardless of individual differences (high or low viscosity) of blood cell samples, thereby obtaining a stable analysis result.

### BRIEF DESCRIPTION OF THE DRAWINGS

FIG. 1 is a schematic view of an analyzer according to an embodiment of the present invention.

FIG. 2 is a schematic view of a sample dispensing mechanism.

FIG. 3 is a flowchart of processing for dispensing a blood cell sample.

FIG. 4 is a flowchart of processing for preparing a diluted sample of a blood cell sample.

FIG. 5 is a graph illustrating a relationship between a pressure waveform and time during sample suction of blood cell samples of different viscosities.

FIG. 6 is a graph illustrating a relationship between a discharge operation amount and a pressure average during suction.

FIG. 7 is a graph illustrating a relationship between a discharge operation amount and an actual discharge amount (with a sample with a pressure sensor output average during suction of 0.8 V).

FIG. 8 is a schematic view of an analyzer according to a variation example of an embodiment according to the present invention.

FIG. 9 is a graph illustrating a relationship between a discharge operation amount and a suction pressure integral value in a variation example of an embodiment according to the present invention.

### BEST MODE FOR CARRYING OUT THE INVENTION

Hereinafter, a preferred embodiment of the dispenser, analyzer and dispensing method according to the present invention will be described in detail with reference to the attached drawings. It should be noted that the present invention is not necessarily limited to these embodiments. Various modifications can be applied to the present invention within the scope that does not depart from the gist of the present invention. In addition, with regard to the description of the drawings, identical portions are added with the same reference numerals. Also, the “liquid” in the present specification includes colloidal solutions, such as whole blood, as well as dispersed particles, such as blood cells.

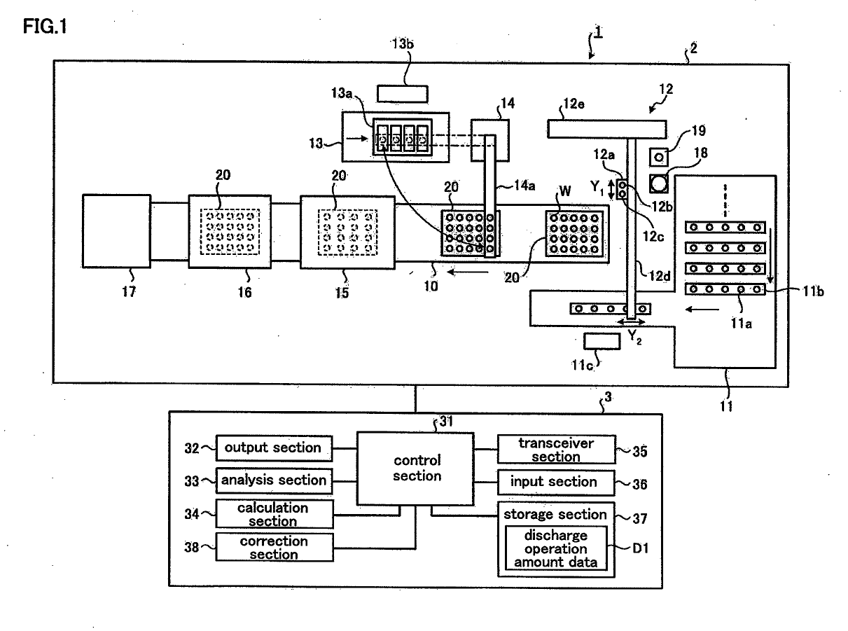

FIG. 1 is a schematic view illustrating a structure of an analyzer according to the present embodiment. As illustrated in FIG. 1, an analyzer 1 according to the present embodiment comprises: a measurement mechanism 2 for dispensing a sample and a reagent to be analyzed, respectively in a given well W (reaction container) of a microplate 20 to optically measure a reaction caused in the well W; and a control mechanism 3 for controlling the overall analyzer 1 including the measurement mechanism 2 and for analyzing a measurement result by the measurement mechanism 2. The analyzer 1 automatically performs an immunological analysis on a plurality of samples with the two mechanisms in cooperation with each other. The microplate 20 is a plate which is formed with a transparent material, such as acrylic, and has a large number of holes, referred to as a well W, opened on the surface of the microplate. The wells W house a sample, each of which is a hole with an inclined plane formed therein. The wells W are arranged in a matrix on the surface of the microplate 20.

The measurement mechanism 2 broadly comprises: a plate conveying lane 10; a sample transfer section 11; a sample dispensing mechanism 12; a reagent transfer section 13; a reagent dispensing mechanism 14; a reaction promoting section 15; a photometry section 16; a plate collecting section 17; a sample diluting section 18; and a probe washing section 19. The control mechanism 3 comprises: a control section 31; an output section 32; an analysis section 33; a calculation section 34; a transceiver section 35; an input section 36; a storage section 37 and a correction section 38. Each of the sections comprised in the measurement mechanism 2 and control mechanism 3 is electrically connected with the control section 31.

The plate conveying lane 10 conveys the microplate 20 to a given position in order to dispense a sample or a reagent to each well W in the microplate 20 and to promote a reaction, and perform photometry, on a liquid in the well W. Under the control by the control section 31, and by the driving of a drive mechanism (not shown), the plate conveying lane 10 conveys the microplate 20 in the direction towards the left, for example, as indicated by the arrow in FIG. 1.

The sample transfer section 11 comprises a plurality of sample racks 11b, each of which retains a plurality of sample containers 11a housing a sample and which are successively transferred in the direction of the arrow in the figure. Samples housed in the sample containers 11a are obtained from blood collected from a donor of the samples, which have been added with an anticoagulant and centrifuged to be separated into a supernatant, or blood plasma, and a sediment, or blood cell (red blood cell) particles. The samples in the sample containers 11a transferred to a given position on the sample transfer section 11 are dispensed by sample dispensing mechanism 12 into given wells W of a microplate 20 arranged and conveyed on the plate conveying lane 10.

A recording medium is attached to a side portion of the sample container 11a, and the recording medium records sample information on the sample housed in the sample container 11a. The recording medium displays various kinds of encoded information, which is optically read. The sample information includes, for example, name, sex, and age of a patient who provided the sample, categories of analysis, and the like.

A corresponding portion of the sample transfer section 11 is provided with a sample reading section 11c for optically reading the recording medium. The sample reading section 11c emits infrared ray or visible light to the recording medium and processes reflected light from the recording medium to read information of the recording medium. The sample reading section 11c may also capture and process an image of the recording medium, decode image information obtained by the capturing and processing, and obtain information of the recording medium. The sample reading section 11c reads the information of the recording medium attached to the sample container 11a as it passes in front of the sample reading section 11c.

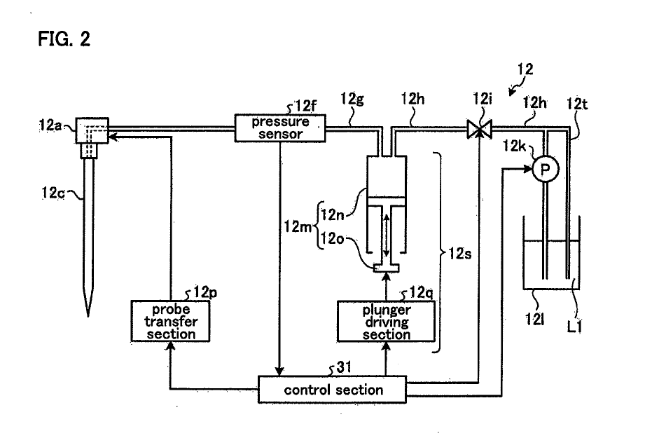

The sample dispensing mechanism 12 comprises: dispensing probes 12b and 12c for sucking and discharging a sample; a probe retaining section 12a for retaining the dispensing probes 12b and 12c; an arm 12d for movably supporting the probe retaining section 12a in the direction of the arrow Y₁ in FIG. 1; and an arm retaining section 12e for movably supporting a base end portion of the arm 12d in the direction of the arrow Y₂. The dispensing probes 12b and 12c are each a dispensing probe for dispensing a blood plasma or blood cell sample. The dispensing probes 12b and 12c are transferred to above a sample container 11a by a probe transfer section 12p illustrated in FIG. 2, and they are lowered into a supernatant, or blood plasma, within the sample container 11a. Then, the dispensing probe 12b sucks the blood plasma sample, and the dispensing probes 12b and 12c are further lowered into the lower layer of blood cells, so that the dispensing probe 12c sucks the blood cell sample. The sucked blood plasma sample is discharged into a given well W of a microplate 20, while the blood cell sample is discharged into the sample diluting section 18 to prepare a diluted sample. In the sample diluting section 18, a diluent is dispensed by a diluent nozzle (not shown), and a diluted sample of the blood cell sample is prepared. The dispensing probe 12c is washed by the dispensing probe washing section 19, and then the diluted sample is sucked from the sample diluting section 18 and discharged into a given well W of a microplate 20.

The reagent transfer section 13 transfers a reagent set 13a, which houses reagents that are to be dispensed in respective wells W in a microplate 20, to a reagent suction position by the reagent dispensing mechanism 14. Required reagents are housed in respective given amounts in the reagent set 13a in accordance with various types of categories of analysis. Each of the reagents contained in one reagent set 13a may be used for a given number of times of dispensing, or may be used for a one time dispensing. The reagent transfer section 13 collects a reagent set 13a which is finished with a given number of times of dispensing processes, and transfers another reagent set 13a to be dispensed next.

A recording medium on which reagent information regarding various reagents housed in the reagent set 13a is recorded, is attached on a side surface portion of the reagent set 13a. The recording medium displays various types of encoded information, which is optically read. A reagent reading section 13b for optically reading the recording medium is provided at a corresponding portion of the reagent transfer section 13. The reagent reading section 13b emits infrared ray or visible ray to the recording medium and process a reflection light from the recording medium to read out the information of the recording medium. Alternatively, the reagent reading section 13b may perform image-capturing processing on the recording medium, decode image information obtained by the image-capturing processing, and obtain information on the recording medium.

The reagent dispensing mechanism 14 comprises an arm 14a, and a probe for sucking and discharging a reagent is attached to a tip portion of the arm 14a. The arm 14a freely performs ascent and descent in a vertical direction as well as a rotation with a vertical line along a base end portion of the arm itself as the central axis. The reagent dispensing mechanism 14 comprises a suction and discharge syringe or a suction and discharge mechanism using a piezoelectric element (not shown). The reagent dispensing mechanism 14 sucks a reagent in a reagent set 13a, which is moved to a given position on the reagent transfer section 13, using each probe; swivels the arm 14a counterclockwise in the figure; and discharges each reagent that corresponds to each well W of a microplate 20 conveyed to a given position on the plate conveying lane 10 to perform dispensation.

The react ion promoting section 15 promotes a reaction of a sample with a reagent dispensed in a microplate 20, performs an antigen-antibody-reaction, and forms an agglutination pattern on a bottom surface of each well W of the microplate 20. The reaction promoting section 15 stirs the sample and reagent in the well W by vibrating the microplate 20. Furthermore, the reaction promoting section 15 settles the microplate 20 still for a given period of time in accordance with the content of the analysis method, for example, to promote natural precipitation or the like of blood cell particles. Furthermore, the reaction promoting section 15 manipulates minute particles present in the well W by, for example, applying a given magnetic field.

The photometry section 16 photometrically detects the agglutination pattern formed in the well W. The photometry section 16 is configured with, for example, a CCD camera, and the photometry section 16 captures an image of each well W on the microplate 20 from the above to output image information of a captured image of the agglutination pattern formed in each well W. The photometry section 16 may also comprise: a light emitting section for irradiating a given light to each well W of the microplate 20; and a light receiving section for receiving light occurred from a suspected fluid in each well W, and may output the brightness of the light occurred from the suspected fluid as a photometric result.

The plate collecting section 17 collects a microplate 20 that has completed the photometric processing by the photometry section 16. The collected microplate 20 is washed by a washing section (not shown) through suction and discharge of a mixture liquid in each well W, and injection and suction of a washing liquid. The washed microplate 20 is reused. Depending on the test item, the microplate 20 may be disposed of after a completion of a measurement.

Next, the control mechanism 3 will be described. The control section 31 is configured with a CPU and the like, and controls the processing and movement of each section of the analyzer 1. The control section 31 performs a given input and output control on information which is input to and output from these constituents. The control section 31 also performs given information processing on the information.

The output section 32 is configured with a display, a printer, a speaker and the like, and the output section 32 outputs various types of information including analysis information generated by the analysis section 33.

The analysis section 33 analyzes an antigen-antibody-reaction based on a photometric result measured by the photometry section 16. When the photometry section 16 outputs image information, the analysis section 33 processes the image information output by the photometry section 16 and obtains a photometric value in accordance with the brightness of a sample. The analysis section 33 also calculates parameters, such as SPC (clearness of the edge of an image at the center portion), P (brightness of a peripheral portion), C (brightness of the center portion) and LIA (area of an image at the center portion), used for determination of negative or positive of agglutination reactions, and compares the parameters with threshold values of respective parameters, such as SPC, P, C and LIA, stored in the storage section 37. The parameters of SPC, P and C are obtained from the values of 0 to 99, and the parameter of LIA is obtained from the values of 0 to 999. From a comparison of the numerical value of the calculated parameter and the threshold value of the parameter, it is possible to determine either of + (positive), − (negative) or ? (undetermined; a case where the comparison result is in between the positive and negative and it is not possible to determine either of the two) for each well W.

The transceiver section 35 has a function as an interface for performing transmission and reception of information in accordance to a given format via a communication network (not shown). The input section 36 is configured with a keyboard, a mouse, a microphone or the like, for obtaining, from the outside, various types of information necessary for an analysis of a sample, instruction information for analysis movements, and the like. The input section 36 also outputs to the control section 31 an extraction menu for a screen display.

The storage section 37 is configured with: a hard disk for magnetically storing information; and a memory for loading and electrically storing various types of programs from the hard disk when the analyzer 1 executes some processing, which programs are associated with the processing. The storage section 37 may comprise an auxiliary storage device capable of reading information stored on a storage medium, such as a CD-ROM, a DVD-ROM and a PC card. The storage section 37 also has a discharge operation amount data D1. The discharge operation amount data D1 represents a correlation between an average pressure value and a discharge operation amount during liquid suction at a sample dispensing mechanism 12, and the data D1 is set for each discharge set amount. The discharge operation amount data D1 is obtained from a relationship between an actual discharge amount from a dispensing probe and a discharge operation amount of a pressure generating means including a syringe pump 12s to be described later, and the like, when liquids with different viscosities are discharged by a dispensing probe 12c for dispensing a blood cell sample. In the present specification, the discharge operation amount means a product of a plunger travel distance and a cross-sectional area of a columnar portion of a cylinder of a syringe pump 12s (see FIG. 2) used as a pressure generating means.

The calculation section 34 calculates an average value of in-line pressures during suction of a blood cell sample by the dispensing probe 12c, in-line pressures of which are measured by a pressure sensor 12f (see FIG. 2) that the sample dispensing mechanism 12 comprises.

The correction section 38 corrects a discharge operation amount of a plunger driving section 12q for discharging a given discharge amount, using an average pressure amount during suction of a blood cell sample, which is calculated by the calculation section 34, and based on the discharge operation amount data D1 stored in the storage section 37. So as to allow the syringe pump 12s to operate for the discharge operation amount corrected by the correction section 38, the control section 31 transmits a control signal to the plunger driving section 12q and allows a desired discharge amount to be discharged from the dispensing probe 12c.

In the analyzer 1 configured as described above, the sample dispensing mechanism 12 dispenses the sample in the sample container 11a, and the reagent dispensing mechanism 14 dispenses each reagent in the reagent set 13a, to a plurality of microplates 20 that are successively conveyed. Then, the photometry section 16 performs brightness measurement of a sample in which the sample has reacted with a reagent, and the analysis section 33 analyzes this measurement result. As a result, analysis on the antigen-antibody-reaction of the sample and the like are automatically performed.

Next, processing for dispensing a blood cell sample will be described with reference to FIGS. 2 to 6. FIG. 2 is a schematic view of a sample dispensing mechanism 12. In FIG. 2, the dispensing probe 12b, arm 12d and arm retaining section 12e for dispensing a blood plasma sample are omitted for the simplicity of the description.

As illustrated in FIG. 2, the sample dispensing mechanism 12 broadly comprises: a dispensing probe 12c; a pressure sensor 12f; a liquid sending pump 12k; a tank 12l; a probe transportation section 12p; and a syringe pump 12s.

An end of a pipe 12g is connected to a base end of the dispensing probe 12c. The other end of the pipe 12g is connected to a syringe 12m. Furthermore, a pressure sensor 12f is positioned in the middle of the pipe 12g, and the pressure sensor 12f converts the pressure within the pipe 12g into voltage and outputs the voltage. The syringe 12m comprises: a tube-shaped cylinder 12n, to which the other end of the pipe 12g is connected; and a plunger 12o provided to be capable of moving back and forth within the cylinder 12n while sliding the inner wall surface of the cylinder 12n. The plunger 12o is connected with the plunger driving section 12q. The syringe pump 12s is constituted of the cylinder 12n, plunger 12o and plunger driving section 12q described above. The plunger driving section 12q is configured with, for example, a linear motor and performs the back and forth movement of the plunger 12o with respect to the cylinder 12n. An end of a pipe 12h is connected with the cylinder 12n of the syringe 12m. The other end of the pipe 12h is connected with the tank 12l for housing pressurized-out water L1. In addition, an electromagnetic valve 12i and a liquid sending pump 12k are connected in the middle of the pipe 12h. For the pressurized-out water L1, an incompressible fluid, such as distilled water or degassed water, is used. The pressurized-out water L1 is also used as a washing liquid for washing the inside of the dispensing probe 12c.

The sample dispensing mechanism 12 drives the liquid sending pump 12k and opens the electromagnetic valve 12i, so that the pressurized-out water L1 housed in the tank 12l can be filled in the cylinder 12n through the pipe 12h and further be filled up to the tip of the dispensing probe 12c through the pipe 12g from the cylinder 12n. In such a state where the pressurized-out water L1 is filled to the tip of the dispensing probe 12c as described above, the electromagnetic valve 12i is closed and the pressurized-out water L1 sent by the pump 12k is allowed to be circulated back to the tank 12l through a reverse pipe 12t. When a blood cell sample is sucked, the plunger driving section 12q is driven to move the plunger 12o backward with respect to the cylinder 12n, so that suction pressure will be applied to the tip portion of the dispensing probe 12c through the pressurized-out water L1 and the blood cell sample will be sucked due to this suction pressure. On the other hand, when a blood cell sample is discharged, the plunger driving section 12q is driven to move the plunger 12o forward with respect to the cylinder 12n, so that discharge pressure will be applied to the tip portion of the dispensing probe 12c through the pressurized-out water L1 and the blood cell sample will be discharged due to this discharge pressure.

Although not clearly illustrated in the figure, the sample dispensing mechanism 12 has liquid level detecting functions for detecting a blood plasma-blood cell interface and a liquid level of a sample in a sample container 11a. The liquid level detecting functions include, for example, a function for detecting a liquid level and an interface from the change in an impedance in between the dispensing probes 12b and 12c when the dispensing probes 12b and 12c make a contact with a sample.

The control section 31 controls the probe transfer section 12p so as to transfer the dispensing probe 12c to a sample suction position, a sample discharge position, a diluted sample suction position and a dispensing probe washing position; and the control section 31 controls the opening and closing of the electromagnetic valve 12i and the driving of the liquid sending pump 12k so as to fill the pressurized-out water L1 into the pipes 12h and 12g and dispensing probe 12c. Further, the control section 31 controls the driving of the plunger driving section 12q so as to suck and discharge a blood cell sample through the dispensing probe 12c. In the present embodiment, the control section 31, which the control mechanism of the analyzer 1 comprises, controls each element of the sample dispensing mechanism 12, a control mechanism for controlling each element of the sample dispensing mechanism 12 may be provided within the sample dispensing mechanism 12.

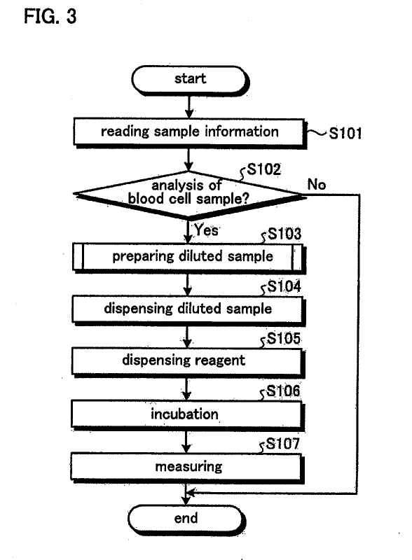

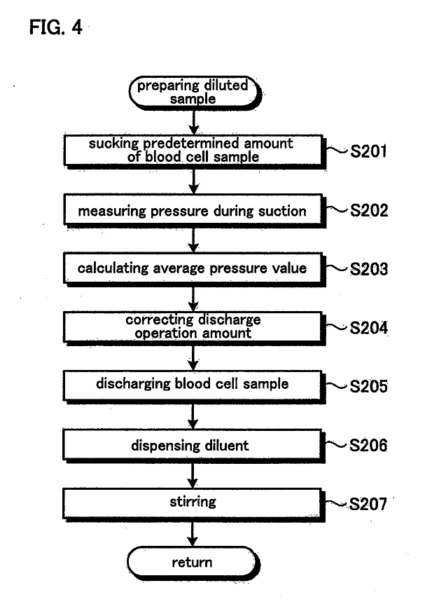

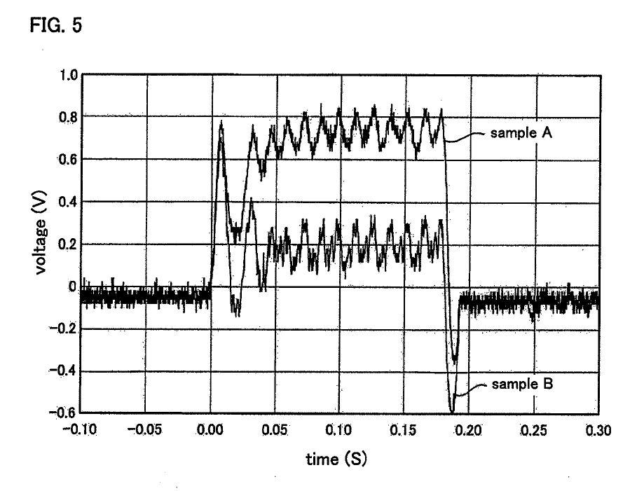

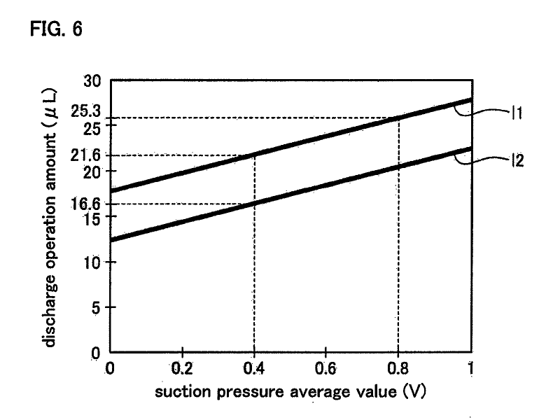

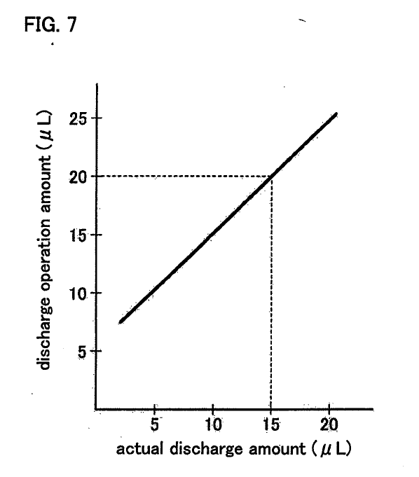

Next, with reference to FIGS. 3 to 7, processing for analyzing a blood cell sample will be described. FIG. 3 is a flowchart of processing for analyzing a blood cell sample. FIG. 4 is a flowchart of processing for preparing a diluted sample with a blood cell sample. FIG. 5 is a graph illustrating a relationship between a pressure waveform and time during sample suction of blood cell samples A and B of different viscosities. FIG. 6 is a graph illustrating a relationship between a discharge operation amount and a pressure average during suction. FIG. 7 is a graph illustrating a relationship between a discharge operation amount and an actual discharge amount with regard to a sample A with a pressure average during sample suction of 0.8V in a converted voltage value.

First, the sample reading sect ion 11c reads out sample information, such as a test item, from the recording medium attached to a sample container 11a to be analyzed, and sends the sample information to the control section 31 (step S101). The control section 31 checks whether or not a test item for a blood cell sample has been ordered, based on the sent sample information (step S102). If the analysis has not been ordered for the blood cell sample (step S102: No), processing for analyzing the blood cell sample is ended. If the analysis has been ordered for the blood cell sample (step S102: Yes), the control section 31 controls the processing so that a diluted sample of the blood cell sample is prepared at the sample diluting section 18 (step S103). After the preparation of the diluted sample, the diluted sample is sucked through the dispensing probe 12c that performs the dispensing of the blood cell sample, and the diluted sample is discharged into a well Win the microplate 20 for dispensing (step S104). Thereafter, a reagent is dispensed by the reagent dispensing mechanism 14 into the well W in which the diluted sample has been dispensed (step S105), a reaction thereof is promoted by the reaction promoting section 15 (step S106), and the photometry section 16 photometrically detects a agglutination pattern in the well W (step S107), and the processing for analyzing the blood cell sample ends. Note that the dispensing of the diluted sample at the step S104 described above may be performed without the correction of the discharge operation amount based on the pressure average during the suction of the diluted sample, or the dispensing may be performed with the correction of the discharge operation amount to be described later.

For the processing for diluting the sample at the step S103, first, the plunger 12o is moved backwards with respect to the cylinder 12n by the driving of the plunger driving section 12q under the control by the control section 31, so that the dispensing probe 12c sucks the blood cell sample in the lower layer component housed in the sample container 11a (step S201). The amount of the sample sucked is an amount set for preparing a diluted sample added with an excess sample amount. For example, if an excess sample amount is 10 μL and a predetermined sample amount is 20 μL, then 30 μL is sucked. While the excess sample amount is normally set in consideration of the sample diluted due to pressurized-out water or the like, the sample amount to be excessively sucked in the present embodiment is set in consideration of reliably sucking a predetermined amount of sample required for analysis.

The pressure sensor 12f measures a pressure within the pipe 12g during the suction of the blood cell sample (step S202), and sends the pressure, as a pressure signal (voltage), to the control section 31. FIG. 5 is a graph illustrating a relationship between a pressure and time during sample suction of blood cell samples A and B of different viscosities, in which the suction of a blood cell sample is performed by the syringe pump 12s during the time from 0.00 second to 0.19 second. As illustrated in FIG. 5, the pressure during suction is high with the blood cell sample A having higher viscosity, whereas the pressure during suction is lower with the blood cell sample B having low viscosity. Due to large differences in the pressure during suction depending on blood cell samples, the amount sucked into the dispensing probe 12c will be different even if the suction is performed by the same syringe pump 12s and at the same suction operation amount. Furthermore, the amount of the sample discharged from the dispensing probe 12c will be different even if the discharging is performed by the same syringe pump 12s and at the same discharge operation amount. Thus, in the present embodiment, the average of pressures at the suction of blood cell samples is obtained, and the average of pressures at the suction is used to correct to a discharge operation amount, which allows a predetermined sample amount to be discharged.

The calculation section 34 calculates an average pressure value during sample suction, based on pressure signal data, shown in FIG. 5, obtained through the control section 31 (step S203).

The correction section 38 corrects a discharge operation amount of the plunger driving section 12q for discharging a predetermined discharge amount, based on discharge operation amount data D1 stored in the storage section 37, using the average pressure value during sample suction, which is calculated by the calculation section 34 (step S204).

The discharge operation amount data D1 is a correction between a discharge operation amount and an average pressure value during liquid suction, set for each desired discharge amount. The discharge operation amount data D1 is obtained from the relationship between a discharge operation amount of the syringe pump 12s when discharging blood cell samples having different viscosities, and an actual discharge amount, and the data D1 is expressed by such a graph as illustrated in FIG. 6. The axis of abscissas refers to an average pressure value during sample suction (output average value of a pressure sensor), and the axis of ordinates refers to a discharge operation amount of the syringe pump 12s output from the control section 31 to the plunger driving section 12q. In FIG. 6, the line 11 refers to a relation of a blood cell discharge amount of 20 μL, and the line 12 refers to a relation of a blood cell discharge amount of 15 μL.

When a predetermined discharge amount of a blood cell sample is 20 μL, the correction section 38 refers to the line L1 in FIG. 6, which is the relation of the discharge amount 20 μL, to correct the discharge operation amount of the syringe pump 12s. For example, when a pressure sensor output average during blood cell sample suction is 0.4 V, the discharge operation amount of the syringe pump 12s is corrected to 21.6 μL from the relation of the line 11; and when the control section 31 drives the plunger driving section 12q, using control signals corresponding to the discharge operation amount after the correction of 21.6 μL, 20 μL of a blood cell sample will be discharged. Similarly, when a pressure sensor output average during blood cell sample suction is 0.8 V, the discharge operation amount will be corrected to 25.3 μL. When a predetermined discharge amount of a blood cell sample is 15 μL, the correction section 38 refers to the line 12 in FIG. 6, which is the relation of the discharge amount 15 μL, to correct the discharge operation amount of the syringe pump 12s. When a pressure sensor output average during blood cell sample suction is 0.4 V, the discharge operation amount of the syringe pump 12s is corrected to 16.6 μL from the relation of the line 12.

While FIG. 6 illustrates only the relations of the blood cell discharge amounts of 20 μL (line 11) and 15 μL (line 12), relations in accordance with all the sample discharge amounts discharged by the analyzer 1 are stored as the discharge operation amount data D1 in the storage section 37, and the discharge operation amount is corrected from the pressure sensor output average value during blood cell sample suction in accordance with a discharge amount.

As described above, after the correction section 38 corrects a discharge operation amount of a predetermined discharge amount, the control section 31 sends control signals in accordance with the discharge operation amount after the correction, to the, plunger driving section 12q, allowing a predetermined amount of a blood cell sample to be discharged from the dispensing probe 12c to the sample diluting section 18 (step S205). A diluent is dispensed into the sample diluting section 18 almost simultaneously with the discharging of the blood cell sample (step S206), and the dispensed sample and diluent are stirred by a stirring mechanism (step S207) to prepare a diluted sample. It is also noted that after the dispensing of the blood cell sample by the dispensing probe 12c into the sample diluting section 18, the disposal and washing off of the sample remaining inside the dispensing probe 12c is performed within the dispensing probe washing section 19.

Hereinafter, a method for obtaining the correlation between the average pressure value and discharge operation amount illustrated in FIG. 6 will be briefly described.

First, a plurality of blood cell samples having different viscosities, i.e., different average pressure values during suction, are provided. For each sample, the dispensing of the sample is performed while the pressure during the suction is monitored. Here, while the suction amount of the sample is set to be an excess sample amount of 10 μL+a required sample amount of 20 μL=30 μL, this 30 μL is a suction operation amount sent from the control section 31 to the plunger driving section 12q, and the correction of the suction operation amount will not be performed. Thus, depending on the viscosity of the blood cell sample to be sucked, the actually sucked sample amount will be different.

With regard to the sucked sample, the discharge operation amount is varied and the discharging of the blood cell is performed into each test tube. A discharge test with a varied discharge operation amount is performed with a constant discharge rate (moving rate of the plunger 12o).

A predetermined amount (e.g., 1,000 μL) of a physiological saline solution is added to the blood cell sample actually discharged into the test tube, and they are sufficiently stirred. Subsequently, the number of red blood cells (number/μL) and an average red blood cell volume (fL) are measured using a blood cell counter. From the measured data, the amount of actually discharged red blood cell is obtained using the formula below.

Amount of discharged blood cell=the number of red blood cells×(average red blood cell volume×10⁻⁹)×amount of added physiological saline solution/(1−the number of red blood cells×(average red blood cell volume×10⁻⁹)) (1)

From the amount of red blood cells calculated using the formula (1) described above, the relationship between the amount of the actually discharged sample and the discharge operation amount is obtained. An example of the result is illustrated in FIG. 7. FIG. 7 is a graph illustrating the relationship between a discharge operation amount and an actual discharge amount of a sample with an average pressure value of 0.8 V during the sample suction.

As illustrated in FIG. 7, in a case of a sample having such high viscosity that the average pressure value during the suction reaches 0.8 V, even if the discharge operation amount for 15 μL is sent to the plunger driving section 12q, the amount of the actually discharged sample is 10 μL. In order to discharge 15 μL of a sample with an average pressure value during suction of 0.8 V from the dispensing probe 12c, it is necessary to send a discharge operation amount that is greater than 15 μL to the plunger driving section 12q. In order to discharge 15 μL of a sample with an average pressure value of 0.8 V, it can be understood that the discharge operation amount is corrected to be 20 μL (see FIG. 7).

The same sort of testing is performed on a plurality of samples having different viscosities, to obtain a relationship between discharge operation amounts and the amounts of the samples actually discharged. Based on the data obtained, the relationship between the suction pressure average and the discharge operation amount illustrated in FIG. 6 is obtained.

In the present invention, based on a preprogrammed correlation (discharge operation amount data D1) between a discharge operation amount and a pressure average during sample suction, a correction for a discharge operation amount can be made for a desired amount to be discharged from a pressure average during sample suction, and the syringe pump can be controlled. Thus, regardless of individual differences (high or low viscosity) of the samples, a predetermined dispensing amount can be dispensed accurately. It is also possible to provide a pressure sensor in the reagent dispensing mechanism 14, similarly to the sample dispensing mechanism 12, to calculate an average pressure value during suction so that the discharge operation amount can be corrected and then dispensed based on the discharge operation amount data D1 (different discharge operation amount data may also be provided for reagents). In such a case, accuracy in the dispensation can be maintained even in dispensing a reagent having high viscosity.

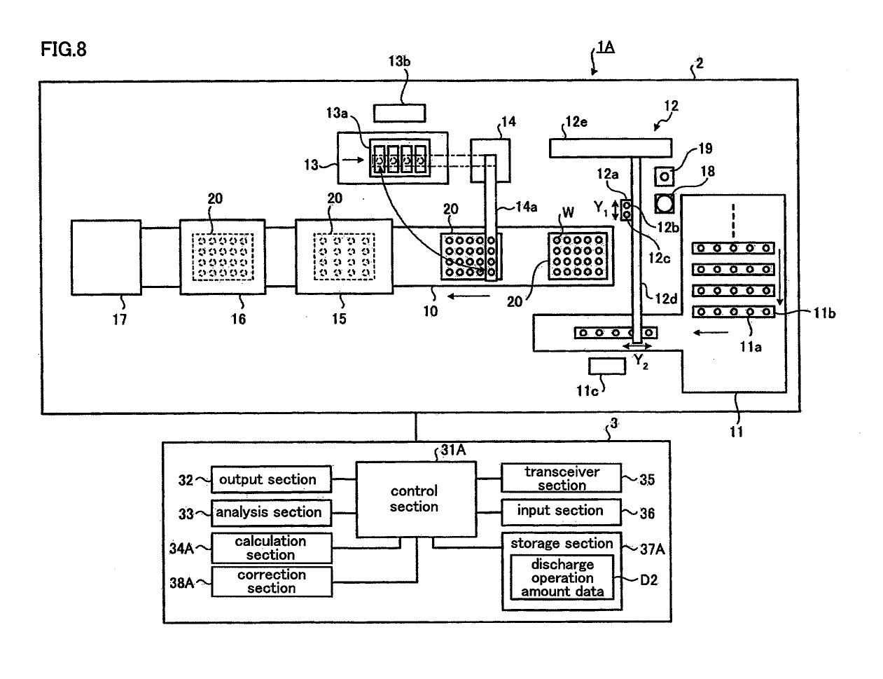

As a variation example of the embodiment according to the present invention described above, an analyzer 1A illustrated in FIG. 8 is exemplified. FIG. 8 is a schematic view of the analyzer 1A. The analyzer 1A performs analysis as follows: a calculation section 34A calculates a pressure integral value from pressure data during sample suction measured by a pressure sensor 12f; a correction section 38A corrects a discharge operation amount from the pressure integral value, based on discharge operation amount data D2 stored in a storage section 37A; and a control section 31A sends control signals in accordance with the corrected discharge operation amount, to a sample dispensing mechanism 12, so that a predetermined amount of a sample is discharged.

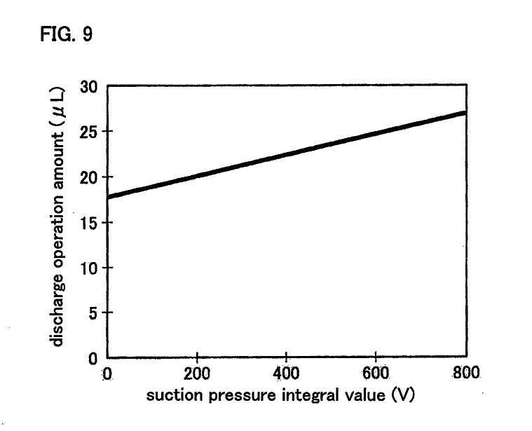

The discharge operation amount data D2 stored in the storage section 37A is stored as a correlation between a discharge operation amount and a suction pressure integral value as illustrated in FIG. 9. FIG. 9 is a graph illustrating a relationship between a discharge operation amount and a suction pressure integral value in the variation example of the embodiment according to the present invention. The analyzer 1A is also capable of accurately dispensing a predetermined dispensing amount regardless of individual differences (high or low viscosity) of samples.

A control program for controlling the processing executed by the analyzer 1 is installed in the storage section 37 or storage section 37A of the control mechanism 3 illustrated in FIG. 1 or 7. In general, installation of such a control program in a memory of a computer allows the computer to function as part or all of the control mechanism 3 (FIG. 1 or 7). Such a control program may be installed in a memory prior to shipping of the computer, or may be installed in the memory after the shipping of the computer. The program may be installed in the memory of the computer by reading the program stored in a recording medium. Alternatively, a program downloaded through a network, such as the Internet, maybe installed in the memory of the computer. For the computer, any type of computer may be used.

Once the control program is installed in the computer, the computer functions as part or all of the control mechanism 3 (FIG. 1 or 7). In this case, the control mechanism 3 (FIG. 1 or 7) being in operation means a controlling method corresponding to the installed control program is executed. This is because the controlling method corresponds to a method for operating the control mechanisms.

As described above, the present invention is exemplified by the use of its preferred embodiment. However, the present invention should not be interpreted solely based on the embodiment described above. It is understood that the scope of the present invention should be interpreted solely based on the claims. It is also understood that those skilled in the art can implement equivalent scope of technology, based on the description of the present invention and common knowledge from the description of the detailed preferred embodiment of the present invention. Furthermore, it is understood that any patent, any patent application and any references cited in the present specification should be incorporated by reference in the present specification in the same manner as the contents are specifically described therein.

The present application claims priority to Japanese Patent Application No. 2009-235626, and it is understood that the entire contents of which are incorporated by reference herein as a part constituting the present specification in the same manner as the contents are specifically described in the present specification.

### INDUSTRIAL APPLICABILITY

As described above, the dispenser, analyzer and dispensing method according to the present invention are useful for an analyzer with a blood cell sample or a whole blood sample as an analysis subject, and they are particularly suitable in the field in which accuracy in analysis is required.

### REFERENCE SIGNS LIST

1, 1A analyzer

2 measurement mechanism

3 control mechanism

10 plate conveying lane

11 sample transfer section

11a sample container

11b sample rack

11c sample reading section

12 sample dispensing mechanism

12a probe retaining section

12b, 12c dispensing probe

12d arm

12e arm retaining section

13 reagent transfer section

13a reagent set

13b reagent reading section

14 reagent dispensing mechanism

15 reaction promoting section

16 photometry section

17 plate collecting section

18 sample diluting section

19 probe washing section

20 microplate

31, 31A control section

32 output section

33 analysis section

34, 34A calculation section

35 transceiver section

36 input section

37, 37A storage section

38, 38A correction section

L1 pressurized-out water

D1, D2 discharge operation amount data

W well

1. A dispenser of a liquid including a sample or a reagent, the dispenser comprising:
pressure generating means for applying suction pressure or discharge pressure through pressurized-out water filled in a pipe connected with a dispensing probe;
a dispensing probe for sucking and discharging a liquid including a sample or a reagent;
pressure measuring means for measuring pressure within the pipe during liquid suction by the dispensing probe;
calculating means for calculating an average pressure value during liquid suction measured by the pressure measuring means;
storage means for storing a correlation between an average pressure value and a discharge operation amount during liquid suction, set for each predetermined discharge amount;
correction means for correcting a discharge operation amount of the pressure generating means, based on a correlation stored in the storage means, using the average pressure value during suction calculated by the calculating means; and
control means for controlling the pressure generating means to allow a predetermined discharge amount to be discharged from the dispensing probe, based on the discharge operation amount corrected by the correction means.

2. A dispenser of a liquid including a sample or a reagent, the dispenser comprising:
pressure generating means for applying suction pressure or discharge pressure through pressurized-out water filled in a pipe connected with a dispensing probe;
a dispensing probe for sucking and discharging a liquid including a sample or a reagent;
pressure measuring means for measuring pressure within the pipe during liquid suction by the dispensing probe;
calculating means for calculating a pressure integral value during liquid suction measured by the pressure measuring means;
storage means for storing a correlation between a pressure integral value and a discharge operation amount during liquid suction, set for each predetermined discharge amount;
correction means for correcting a discharge operation amount of the pressure generating means, based on a correlation stored in the storage means, using the pressure integral value during suction calculated by the calculating means; and
control means for controlling the pressure generating means to discharge a predetermined discharge amount from the dispensing probe, based on the discharge operation amount corrected by the correction means.

3. The dispenser according to a claim 1, wherein the pressure generating means is a syringe pump.

4. The dispenser according to claim 1, wherein liquid discharging by the dispensing probe is performed at a predetermined discharging rate.

5. The dispenser according to claim 1, wherein the sample is a blood cell sample or a whole blood sample.

6. An analyzer for analyzing a reactant of a sample and a reagent based on optical measurement, comprising:
the dispenser according to claim 1; and
measurement means for optically measuring the reactant of the sample and the reagent.

7. A dispensing method for a dispenser that applies suction pressure or discharge pressure by pressure generating means through pressurized-out water filled within a pipe connected to a dispensing probe, sucks and discharges a liquid including a sample or a reagent by the dispensing probe, the method comprising:
a pressure measuring step of measuring pressure within the pipe during liquid suction by the dispensing probe;
a calculating step of calculating an average pressure value during liquid suction measured at the pressure measuring step;
a correcting step of correcting a discharge operation amount of the pressure generating means, using the average pressure value during suction calculated at the calculating step, based on a correlation between an average pressure value and a discharge operation amount, set for each predetermined discharge amount, stored in storage means; and
a discharge step of controlling the pressure generating means and allowing a predetermined discharge amount to be discharged from the dispensing probe, based on the discharge operation amount corrected at the correcting step.

8. A dispensing method for a dispenser that applies suction pressure or discharge pressure by pressure generating means through pressurized-out water filled within a pipe connected to a dispensing probe, and sucks and discharges a liquid including a sample or a reagent by the dispensing probe, the method comprising:
a pressure measuring step of measuring pressure within the pipe during liquid suction by the dispensing probe;
a calculating step of calculating a pressure integral value during liquid suction measured at the pressure measuring step;
a correcting step of correcting a discharge operation amount of the pressure generating means, using the pressure integral value during suction calculated at the calculating step, based on a correlation between a pressure integral value and a discharge operation amount, set for each predetermined discharge amount, stored in storage means; and
a discharge step of controlling the pressure generating means and allowing a predetermined discharge amount to be discharged from the dispensing probe, based on the discharge operation amount corrected at the correcting step.

9. A control program used in a dispensing method for a dispenser that applies suction pressure or discharge pressure by pressure generating means through pressurized-out water filled within a pipe connected to a dispensing probe, and sucks and discharges a liquid including a sample or a reagent by the dispensing probe, the control program being for implementing processing executed by the dispenser in accordance with an instruction from an operator, the dispenser comprising a storage section that stores a plurality of sets of a series of executive processing procedures executed by the dispenser, and each plurality of sets of a series of executive processing procedures corresponding to a series of operation procedures by the operator, the dispensing method comprising:
a pressure measuring step of measuring pressure within the pipe during liquid suction by the dispensing probe;
a calculating step of calculating an average pressure value during liquid suction measured at the pressure measuring step;
a correcting step of correcting a discharge operation amount of the pressure generating means, using the average pressure value during suction calculated at the calculating step, based on a correlation between an average pressure value and a discharge operation amount, set for each predetermined discharge amount, stored in storage means; and
a discharge step of controlling the pressure generating means and allowing a predetermined discharge amount to be discharged from the dispensing probe, based on the discharge operation amount corrected at the correcting step.

10. A control program used in a dispensing method for a dispenser that applies suction pressure or discharge pressure by pressure generating means through pressurized-out water filled within a pipe connected to a dispensing probe, and sucks and discharges a liquid including a sample or reagent by the dispensing probe, the control program being for implementing processing executed by the dispenser in accordance with an instruction from an operator, the dispenser comprising a storage section that stores a plurality of sets of a series of executive processing procedures corresponding to a series of operation procedures by the operator, the dispensing method comprising:
a pressure measuring step of measuring pressure within the pipe during liquid suction by the dispensing probe;
a calculating step of calculating a pressure integral value during liquid suction measured at the pressure measuring step;
a correcting step of correcting a discharge operation amount of the pressure generating means using the pressure integral value during suction calculated at the calculating step, based on a correlation between a pressure integral value and a discharge operation amount, set for each predetermined discharge amount, stored in storage means; and
a discharge step of controlling the pressure generating means and allowing a predetermined discharge amount to be discharged from the dispensing probe, based on the discharge operation amount corrected at the correcting step.

11. A computer-readable recording medium for recording a control program used in a dispensing method for a dispenser that applies suction pressure or discharge pressure by pressure generating means through pressurized-out water filled within a pipe connected to a dispensing probe, and sucks and discharges a liquid including a sample or a reagent by the dispensing probe, the control program being for implementing processing executed by the dispenser in accordance with an instruction from an operator, the dispenser comprising a storage section that stores a plurality of sets of a series of executive processing procedures executed by the dispenser, and each plurality of sets of a series of executive processing procedures corresponding to a series of operation procedures by the operator, the dispensing method comprising:
a pressure measuring step of measuring pressure within the pipe during liquid suction by the dispensing probe;
a calculating step of calculating an average pressure value during liquid suction measured at the pressure measuring step;
a correcting step of correcting a discharge operation amount of the pressure generating means, using the average pressure value during suction calculated at the calculating step, based on a correlation between an average pressure value and a discharge operation amount, set for each predetermined discharge amount, stored in storage means; and
a discharge step of controlling the pressure generating means and allowing a predetermined discharge amount to be discharged from the dispensing probe, based on the discharge operation amount corrected at the correcting step.

12. A computer-readable recording medium for recording control program used in a dispensing method for a dispenser that applies suction pressure or discharge pressure by pressure generating means through pressurized-out water filled within a pipe connected to a dispensing probe, and sucks and discharges a liquid including a sample or a reagent by the dispensing probe, the control program being for implementing processing executed by the dispenser in accordance with an instruction from an operator, the dispenser comprising a storage section that stores a plurality of sets of a series of executive processing procedures executed by the dispenser, and each plurality of sets of a series of executive processing procedures corresponding to a series of operation procedures by the operator, the dispensing method comprising:
a pressure measuring step of measuring pressure within the pipe during liquid suction by the dispensing probe;
a calculating step of calculating a pressure integral value during liquid suction measured at the pressure measuring step
a correcting step of correcting a discharge operation amount of the pressure generating means using the pressure integral value during suction calculated at the calculating step, based on a correlation between a pressure integral value and a discharge operation amount, set for each predetermined discharge amount, stored in storage means; and
a discharge step of controlling the pressure generating means and allowing a predetermined discharge amount to be discharged from the dispensing probe, based on the discharge operation amount corrected at the correcting step.
